(19) United States
(12) Patent Application Publication
(10) Pub. No.: US 2016/0180421 A1
(43) Pub. Date: Jun. 23, 2016

(54) CONSUMER-DIRECTED SOCIAL E-COMMERCE RETAILER MARKETPLACE AND OFFER MANAGEMENT SYSTEM

(71) Applicant: Triliant, LLC, Carmel, IN (US)

(72) Inventors: Brian C. Wegner, Zionsville, IN (US); Ryan C. Wegner, Del Mar, CA (US)

(21) Appl. No.: 14/972,703

(22) Filed: Dec. 17, 2015

Related U.S. Application Data
(60) Provisional application No. 62/093,125, filed on Dec. 17, 2014.

(51) Int. Cl. G06Q 30/06; G06Q 50/18; G06Q 50/00

(52) U.S. Cl. CPC G06Q 30/0611; G06Q 50/01; G06Q 50/188

(57) ABSTRACT

A social e-commerce platform, optimized for mobile, providing consumers a user controlled “pull” model with a mufti-variant approach to sourcing retailers for products and to purchase, share, and form communities. A user can make an offer on products, get offers on products, or purchase products at list price provided to the end user. A user specifies a first data set defining a product he or she desires to buy and designated length of time at or by which retailer must provide offers by. The platform receives a second data set from each of one or more retailers. Each such data set includes product-level details, a price that the respective retailer is willing to accept for its sale of the product, available delivery methods, a length of time the offer is valid, and a process is then executed to generate a result that identifies retailers of the product and their offers.

### CROSS-REFERENCE TO RELATED APPLICATION

This U.S. patent application claims priority to U.S. Provisional Patent Application No. 62/093,125 filed Dec. 17, 2014 the disclosure of which is considered part of the disclosure of this application and is hereby incorporated by reference in its entirety.

### FIELD OF THE INVENTION

This invention relates generally to electronic social commerce among, e.g., mobile device or computer end users, and companies that desire to sell products and services to those end users. More specifically, the present invention relates to buyer-oriented method for procuring goods from retailers.

### BACKGROUND

Generally, a consumer wishing to obtain the right item at the best value and quality of product or service they wish to purchase performs research through various online resources (visiting multiple retailer sites or comparison guides), or visits multiple brick-and-mortar retailers to compare prices. The retailer is in the best position to set prices knowing that consumers will limit their searches due to time constraints, and the inconvenience of shopping around. Consumers will generally not find the best deal because it is impractical to visit all the retailers to see their products, prices, and whether they have a clearance event on products in which they are interested.

Further, retailers seemingly have little incentive to innovate in the way they engage prospective consumers. Typically products are offered at a particular price, and in some cases when purchases are made online, the retailer offers free shipping. In addition, retailers generally do not know when a consumer is in need of a product or service. Retailers therefore tend to conduct mass “push” advertising through e-mail, radio, print, internet banner ads, television advertising, and even semi-targeted electronic ads driven by a person's online searches, but rarely is the advertising performed in an informed, personalized, and targeted manner. There is an increasing concern over privacy and the prospect of challenges to businesses that utilize people's private information to promote sales.

Retailers are also geographically limited in multiple ways. A small or mid-size business in one location may not be known to, or considered an option for, a consumer in another location. Those businesses have limited reach to gain new sales. Conversely, a business may find it impractical to offer a consumer living very nearby special treatment (such as someone living very nearby having an auto repair shop pick up their car, make a repair, and deliver the car back to the home), simply because they cannot differentiate between consumers and their locations.

In addition, consumers are bombarded by irrelevant advertising that they must sort through in order to see a promotion that interests them. Consumers have no reasonable way to quickly seek out a range of promotions on products or services they are really interested in. There is a need for consumers to drive the offers they are interested in, rather than the current method of marketers pushing offers to the consumer. Consumers may never become aware of a retailer that offers them the best value or product to fit their needs.

There are various online marketplaces available to consumers looking to purchase goods over the internet. One type of marketplace provides a single web site that hosts pages from multiple providers via a common storefront. Other types of marketplaces, such as ebay.com, provide “forward” auctions wherein users bid to purchase available products. In a typical forward auction, buyers compete to obtain a good or service by offering increasingly higher prices.

Other sites provide reverse auctions, wherein sellers compete between each other to obtain business from the buyer. At a reverse auction site, the site provides tools to enable users to name their own prices and to obtain products and services, such as airline tickets, hotel rooms, car rentals and vacation packages that are available from the site. End users accessing the site select a general location, service level and price; the site maintains an inventory of available products; if a match is obtained, the hotel, rental car company and/or airline, as well as the exact location of the hotel and the exact flight itinerary, is disclosed, typically only after the purchase has gone through.

Prices typically decrease as the sellers undercut each other. However, with most reverse auction sites the user may not know the actual location or the actual good or service they are purchasing. The user is limited in the amount of information they are provided regarding the good or service and do not have full transparency of the product or service they are purchasing. Additionally, the service providers that are bidding against each other are aware of the prices each service provider is offering and typically only one choice is provided to the user. A reverse auction site takes away the control from a user to be able to ensure they are receiving the exact product they want and limits their options to the low bidder.

Other approaches to online retailing include such sites where local retailers define product or service deals that are made available to end user subscribers in the form of a deal-of-the-day that features discounted gift certificates usable at the local companies. There may be a limited number of deals available to be purchased.

Current consumer shopping methods fail to recognize specific consumers that are interested in purchasing a particular product or service until that person arrives in a store or makes an online purchase. Additionally, consumers have a limited ability to compare prices and services from a range of retailers. A consumer having the ability to post a product or service request and receive offers from interested retailers provides consumers with better opportunities to save money or receive enhanced services than if they simply bought from a store or online site at posted prices.

Further, a retailer's inability to provide a personalized offer after the customer has shown interest in a product is generally not an established practice, thereby limiting the retailer's ability to make a sale. Retailers tend to rely on traditional advertising and generalized discounts that do not take an individual view of the consumer.

Another drawback to current processes is the inability of the business to attract consumers that are not familiar with the retailer. General advertising and word of mouth remain as the primary methods of attracting consumers to a business.

There remains a need for improvements in the way consumers engage retailers to obtain the best price and services. Consumers should have the ability to quickly and easily find and select deals that make the most sense for them. They should be able to specify the product and related services they are seeking, and allow retailers to provide offers to them rather than having the consumer seek out the best promotion. Similarly, consumers should be completely informed with the product they are purchasing before commencing a transaction with the retailer. Consumers do not necessarily always want the lowest price item and desire to form relationships with retailers for future transactions.

### BRIEF SUMMARY OF THE INVENTION

In one aspect, this disclosure is related to an on-line electronic social commerce (e-commerce) platform through which consumers that are seeking out products or services for sale can in effect submit a request for offers from participating retailers selling the desired product or service.

In one aspect, this disclosure is related to an apparatus for managing and making transactions in an interactive and conversational environment, comprising at least one hardware processor, a server that is configured to receive a plurality of data sets, a computer memory storing a database configured to store a plurality of algorithms and the plurality of data sets, wherein each algorithm generates a weight and an analytic scorecard for each data set and the analytic scorecard comprising a likelihood of a second data set corresponding to a first data set. The computer memory can further store computer program code executed in at least one of the hardware processors to establish and maintain said plurality of data set and plurality of algorithms. The processors can then be used to receive a first data set from a user that defines a product or service the user desires to obtain, the value range the user is willing to pay to obtain the product or service, and a first pre-determined time period in which the user desires to obtain offers for the product or service.

The apparatus executes iteratively an algorithm to generate a plurality of second data sets that populates a set of outputs related to each data set, wherein each outputs are correlated to a given retailer. The apparatus can update the outputs from continual iterations of the algorithm and provide these updated outputs to the user. Each of the outputs can have a given pre-determined duration before the offer expires. When a user receives the offer, the user can take action in determining which offer to select for purchase. The apparatus generates the outputs in a list and in a manner to avoid undesired offer or data value equilibria. In accordance with the iteratively executed algorithm the offer are preferentially ordered in a list based. The apparatus action facilitates an online transaction between a user and a given one of retailers associated with the offer.

In another aspect, this disclosure is related to a method for managing and making transactions in an interactive environment, comprising establishing and maintaining, within a computing entity, a plurality of data sets and plurality of algorithms, receive a first data set from a user where the user defines a product or service the user desires to obtain, a range of values the user is willing to pay to obtain the product or service, and a first selected time period in which the user desires to obtain offers for the product or service. An algorithm is iteratively executed to automatically retrieve from said memory or computing entity a plurality of second data sets based on an analytic scorecard comparison between said first data set and second data sets. Offers related to each of the second data sets based on the analytic scorecard are populated, wherein said offer are correlated to a given one of retailers. Offers that are generated are provided to a user, together with any update to an offer that results from an iteration of said algorithm, wherein each offer has a given pre-determined duration before said offer is removed. Upon receipt of said offer by said user, the system can take an action, wherein said offers are generated in a list and in a manner to avoid undesired offer, wherein said offer are preferentially ordered in said list based upon iterative execution of said algorithm. A user then can engage in transaction between the user and a given one of retailers associated with an offer. In some embodiments, this transaction can occur online or in person.

In some embodiments the algorithm uses a coefficient factor to generate the analytic scorecard of a second data set. In other embodiments an algorithm can use a coefficient factor and an analytic scorecard to generate an automated offer to said user.

In another aspect, this disclosure is related to a method for managing and making transactions in an interactive environment, comprising establishing and maintaining, within a computing entity, a plurality of data sets and at least one algorithm, receiving an offer from a user for an item corresponding to a second data set provided by a retailer, executing iteratively an algorithm from said computing entity to generate a response to said offer, wherein said response accepts or rejects said offer.

In some embodiments, a system is provided that is based on a technology platform that allows consumers to post a product on that system at varying degrees of detail (for example, a specific product and model number, or a general description) that they are interested in purchasing. The products or services supported by the system are not limited, and may include but not be limited to electronics, apparel, sporting goods, auto services, spa services, vacation deals, and virtually any other product or service that a consumer may wish to purchase. The consumer may specify not only the product, but other requested attributes (i.e.: shipping, in-store pick-up, installation, or any other affiliated request). The consumer may also choose to post a picture, link, or other attachment to their request.

In some embodiments, the system allows the consumer to follow a defined path of categories to identify a product within that path, and may choose to request offers at any level of that path (i.e.: 1) Electronics 2) Television 3) Flat screen television 4) Size of television 5) Display type 6) Specific brand 7) Specific model).

Further, in some embodiments, the system provides a database and system that captures and stores multiple consumer level elements (consumer data), including product level requests, demographic and psychographic information, and other data used to (a) inform retailers of the request and other required information, and (b) facilitate the process of making and fulfilling those offers. The system will also provide functionality to support location-based offers, where consumers are presented with promotions and offers for businesses within their proximity, as well as to enable retailers who are responding to requests to make offers that are valued by taking into account consumer preferences and their location

Another aspect of the present invention relates to a system for a consumer driven offer program that allows a consumer to post requests for product and service offers, comprising a software adapter executed by a data processor to retrieve consumer data over a wide or local area network; a consumer database server comprising operational software and a plurality of consumer accounts, where the database server is configured to store the consumer data and records relating to product and service requests, the consumer requests stored in a consumer account, wherein the database server is operable to transmit the consumer requests to retailer accounts; and a retailer database server comprising operational software and a plurality of retailer accounts, where the database server is configured to store the retailer data, records containing product and service data and descriptions, and consumer offers and other data in a form accessible to registered retailers.

The data processor executes iteratively at least one algorithm comparing the consumer requests to the product data. At least one offer related to the consumer request is populated, wherein the offer is correlated to a given one of retailers. The generated offers are provided to a user, together with any update to an offer that results from an iteration of the algorithm, wherein each offer has a given pre-determined duration before the offer is removed. The user takes an action upon receipt of the offer, wherein the offers are generated in a list and in a manner that avoid undesired data and are preferentially ordered in said list based upon iterative execution of said algorithm and the action facilitates an online transaction between the user and a given one of retailers associated with an offer.

### BRIEF DESCRIPTION OF THE DRAWINGS

The features and advantages of this disclosure, and the manner of attaining them, will be more apparent and better understood by reference to the following descriptions of the disclosed system and process, taken in conjunction with the accompanying drawings, wherein:

FIG. 1 is a service provider platform from which an online marketplace according to this disclosure is provided to users, specifically with regards to users making offers and soliciting offers.

FIG. 2 illustrates a set of detailed data entry for product information.

FIG. 3 is a process flow by which an end user can access an online marketplace and platform to make an offer for a product or service.

FIG. 4 is a process flow by which an end user can access the online marketplace and platform to solicit offers for a product or service.

FIG. 5 illustrates a representative display screen on a mobile device for users wishing to make offers on goods provided by retailers.

FIG. 6 illustrates a representative display screen for user wishing to solicit offers from retailers.

FIG. 7 illustrates a display screen for a retail user for responding to user offer request.

FIG. 8 illustrates a display screen for a retail user for responding with offers or the option to withdraw a previously made offer by the retail user.

FIGS. 9A-D illustrates a conversational graphical user interface of the present invention displayed on a wireless mobile device.

### DETAILED DESCRIPTION OF THE INVENTION

The disclosed system and method may be practiced using a computing infrastructure comprising one or more data processing machines.

For the purposes of promoting an understanding of the principles of the present disclosure, reference will now be made to the embodiments illustrated in the drawing, and specific language will be used to describe the same. It should be appreciated that not all of the features of the components of the figure are necessarily described. Some of these non-discussed features, as well as discussed features are inherent from the figures. Other non-discussed features may be inherent in the system configuration. A consumer may include an individual, a business, or other entity. It will nevertheless be understood that no limitation of the scope of this disclosure is thereby intended.

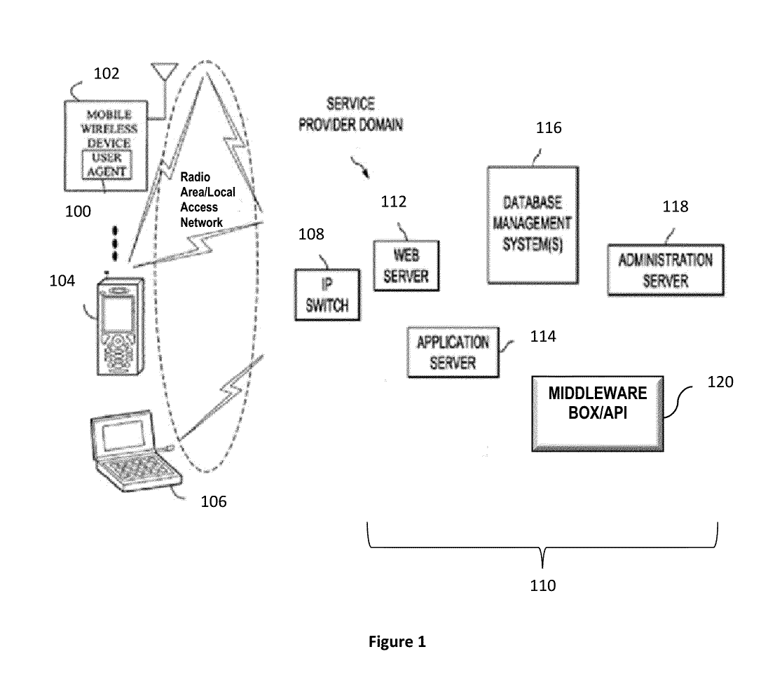

FIG. 1 illustrates a service provider platform for an apparatus for a consumer driven multi-pathway online social marketplace that provides the ability for a consumer to post a product or service they are interested in purchasing in order to obtain offers from a variety of retailers or to make offers on products offered by retailers. A user 100 can access the service provider platform by using a device with internet access or wireless communication capabilities, such as a tablet, cellular phone 104, or personal computer 106. Activity on the service provider platform can be carried out or implemented with a service provider infrastructure that can include an internet protocol (IP) switch/network 108, a set of one or more server machines 110. The server machines 110 can include one or more web server machines 112, application server machines 114, a database management system 116, and administration server machines 118, and a middleware box 120. The middleware box 120 can be used to provide a plurality of application program interfaces (APIs) that can be used to connect from the system out to retailers or consumers for automation process, such as offer responses, product integration, order system integration, shipping information integration, and more. Using the infrastructure, data storing can include the look and feel of a host website, a communications link to a visitor computer, and a processor.

The processor can perform tasks, such as capturing the depiction associated with a host website, retrieving offer related data over a wide area network, and storing the data. The functions of the platform may be optionally implemented in a cloud-based computing architecture, which can enable on-demand network access to a shared pool of configurable computing resources (e.g. servers, processing, memory, storage, networks). These resources can be accessed and released with very little interaction needed between the user and the provider of the service. The network and servers 110 can store consumer profile data that may include consumer data, business or sales data, third party information, and/or desired goods and services data which is stored in a repository in various electronic forms.

The system described herein can use any suitable combination of one or more computing-related features (e.g., systems, machines, processes, programs, functions) that together can facilitate or provide the functionality described in this application. In one exemplary implementation, the system comprises a software executing machine comprises commodity hardware, an operating system, an application runtime environment, and a set of applications or processes and associated data that can provide the functionality of a given system or subsystem. The functionality of the system may be implemented in a standalone machine or across a distributed set of machines.

A consumer that is registered can access the host site with a variety of devices including mobile and stationary computing devices 102 (e.g. cell phone, tablet, personal computer 106, laptop). One exemplary embodiment of the present invention uses a device 102 typically comprised of a central processor, memory, graphical user interface, and a drive. A user 100 can use such a device to access and communicate with the network wirelessly. The device is capable of accessing one or more radio access networks or local area networks coupled to a network, such as an IP network/switch 108 comprising the internet or public telephone system network (PSTN). Any suitable wireless protocol capable of sending and receiving data can be used including, WiFi, GSM/GPRS, CDMA or WiMax. One exemplary device can include a cellular phone 104 that can operate over a wireless data technology, such as GSM or 3G network. The cellular phone 104 can also support wireless local area networks (WLAN), such as WiFi. The device can also include an application that can be used to implement to a user 100, either a retailer or consumer, the functionality of the system and method of the present invention described herein.

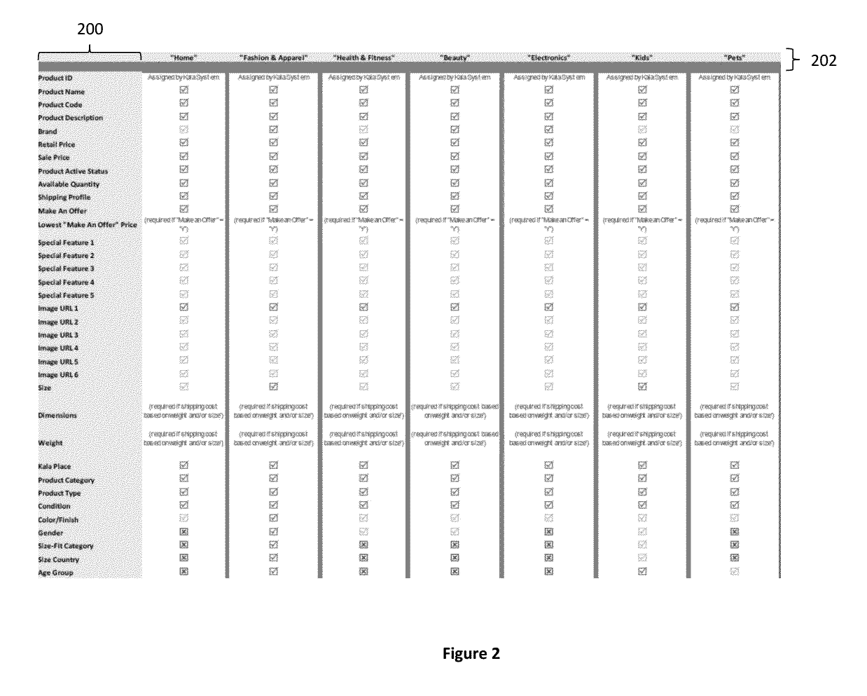

The system of this disclosure includes a database in which particular products or related products are linked to retailers able to fulfill requests. FIG. 2 illustrates product data or information 200 a retailer can provide when enrolling in the system. A retailer can indicate the categories 202 of product and service requests they wish to receive and respond to with offers. In one embodiment, the retailer indicates one or more categories 202 of products and services they are interested in responding to. In another embodiment, a retailer may specify other production information 200 or attributes, such as geographic areas the retailer is open to serving, delivery methods and rates, and other such attributes.

In some embodiments, the system described herein provides for a middleware layer of proprietary APIs, giving the ability to upload product and service level data through an automated data synchronization process to systematically build the product categories 202 and hierarchy. The system can also allow manual entry of product information 200 and service data to create a product hierarchy.

The business or sales data 200 includes data obtained from retailers, for example merchants or manufacturers. This data 200 includes information related to particular products or services the retailer is offering through the system, which consumers can browse for making a possible transaction with the retailer. The information 200 may include business logos, colors, fonts, profile information, product identification codes or product descriptions of items, delivery methods, pricing, product images, brand information, and more. Similar to the data 200 entered by retail users, consumer users when searching can enter in data that may correspond to the data 200 for products they wish to purchase or browse. Additionally, data 200 related to a consumer may also be housed within a database.

The consumer data can consist of demographic, pyschographic, social, and lifestyle information related to a particular consumer. In one embodiment, the software adaptor retrieves this information from services, such as NIELSEN and EPSILON. The system may further scrub social media outlets to obtain additional consumer information. The consumer may additionally provide data by accessing their account through the system. The system can also use information from previous transactions (what the user has bought, saved to their favorites, chosen which product types/categories/genres to like or dislike, brands/companies to follow, social information from their Community interactions in the system, etc.).

This method of advertising utilizes a “pull” method by aggregating all the aforementioned consumer related information to better provide information to possible merchants that may want to provide products to consumers. This can allow a retailer to engage consumers with real impact by offering added value beyond a discounted price, like personalized product features, shipping options, or complementary purchases or add-on services at no cost. Additionally, this allows a retailer to maintain its minimum advertised price because each offer is individualized to each specific user. Consumer users, therefore, are able to control how they interact and do not receive advertisements for goods they are not interested in, while retailers are better able to find consumers who want to be engaged by the retail user.

In some embodiments, the system can deliver the consumer requests in real-time or in a batch mode to retailers, who are then able to create and deliver a customized offers to the consumer for the requested product or service, or enables a retailer to find the request and choose to provide an offer in response to that request. In some embodiments, described further below, the system can match consumer requests and create retailer offer responses in a real-time, automated fashion using a multi-tiered matching algorithm based on relevancy and price (i.e., an apparel request for shoes may be delivered to a shoe retailer, but not an auto parts retailer). A coefficient factor score can also be utilized by the algorithm to determine the value of the offer generated by the algorithm.

The system provides the ability for the retailer to respond through the system by posting an offer in response to the consumer request. The offer response may include details about the offer, including price, duration or timeframe during which the offer is valid, a description of the product or service, a photo or link to the product or service, delivery method, and any other information relevant to the offer. The retailer's offer to the consumer can come to the consumer in a private manner, with only the consumer knowing the details of the offer. In other embodiments, the system allows for open offers, so that businesses are aware of other offers being made and are able to present an offer with knowledge of competing offers made by businesses.

The system can allow a consumer to pay for the product or service through the system, at which point the system can withhold required fees, if any, and then pass the remaining payment to the retailer, together with information needed by the retailer to match the payment to the related order, product or service, as well as other data (such as customer profile data).

The system can notify the retailer of the purchase, as well as the details of the order. In some cases, the system may enable the retailer to view the purchases directly. In other cases, the system may drive messaging through e-mail, direct integration with retailer's transaction processing system via the systems middleware APIs, or by other means to the retailer so that the retailer may fulfill the order in either a manual or automated fashion.

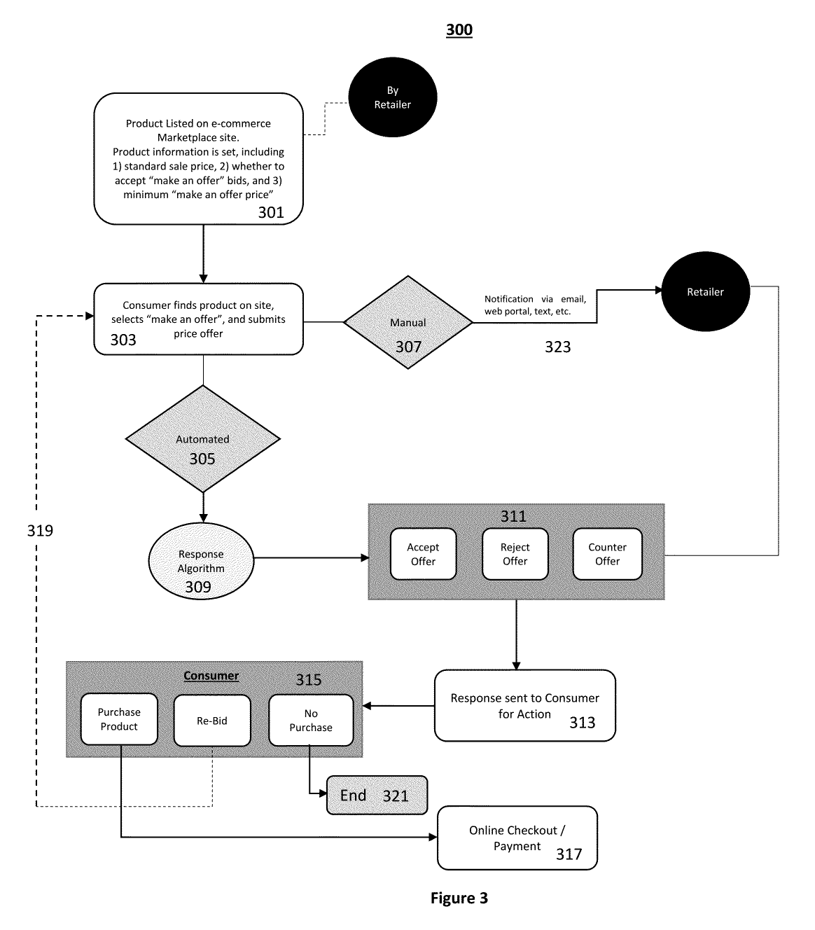

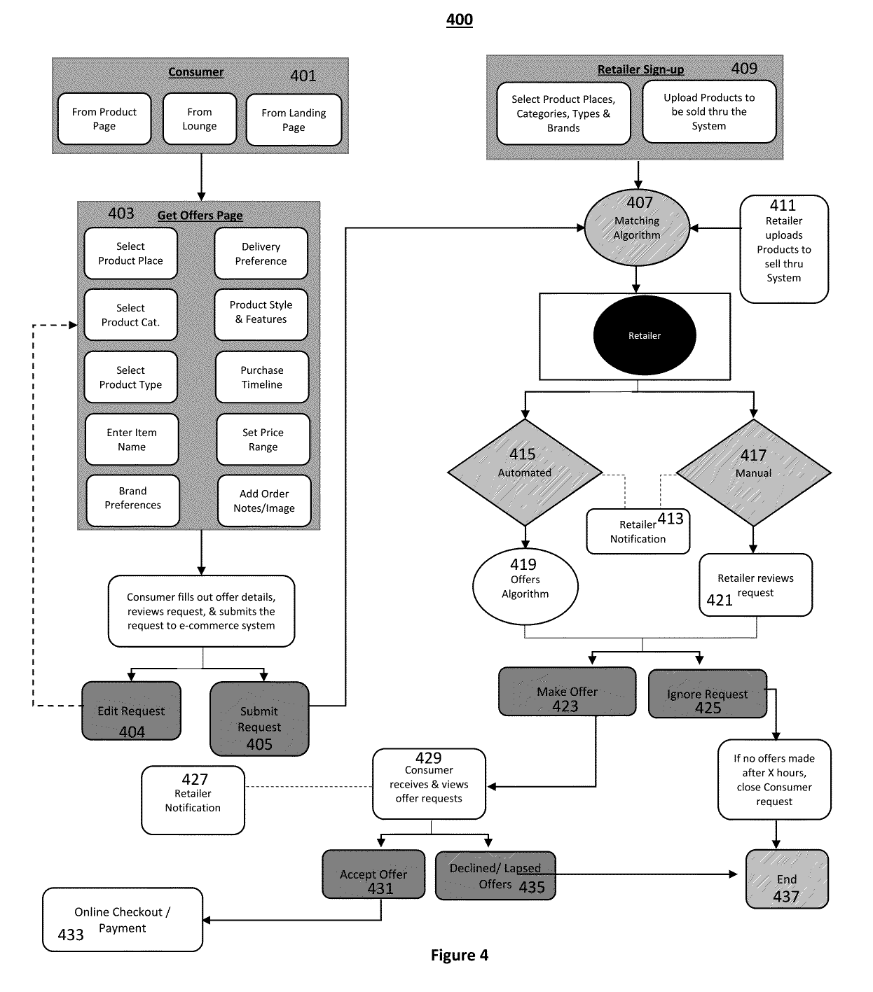

FIGS. 3 and 4 illustrate the two primary approaches for transaction under the present platform. FIG. 3 illustrates a “Make an Offer” approach where a consumer user has found a product or service offered by a retailer user for which he wishes to make a monetary offer different than the listed retail sale price for the product or service. In order for a consumer to make an offer, a retailer must have designated in the first data set they will accept offers for the specific product or service 301. Once finding a retailer who has established they are willing to accept offers, the consumer can choose to make an offer 303 to a retailer for a product or service offered by the retailer. A retailer can either be a third party retailer or a host retailer. An automated 305 or a manual 307 response iteration can occur in the “Make an Offer” pathway depending on how the retailer desires to use the system, which the retailer indicates in the product data set.

Regarding the automated response iteration, in a first data set, a retailer can list the following information for each of their uploaded products: 1) standard product sale price, 2) select whether to allow consumer to “make an offer”, and 3) if data point 2=yes, the retailer sets a minimum “make an offer price” that retailer is willing to accept for the product. If the retailer allows “make an offer” for the product, the consumer can choose to “make an offer” by selecting a price they are willing to pay for the product and submitting it to the system for a response. The system can automatically respond in real time by using a response algorithm 309. The system then executes one of three response outputs 311, 1) accepting the consumer offer, 2) rejecting the consumer offer, or 3) responding with counter-offer (price). The response output 311 is sent 313 to the consumer for a consumer response 315, which is to accept, reject, or make another bid. When either the system or consumer accepts the offer proposal, the consumer can then choose to buy and initiate the standard online purchase process. If a consumer accepts, he or she can then proceed to an online checkout or other payment method 317. In the instance a consumer decides to make another bid, the pathway 300 is then repeated 319 from step 303. Alternatively, if a retailer rejects an offer, the “make an offer” process ends 321.

Similarly, in a manual iteration 307, a retailer can list at least the following information for each product: 1) standard product sale price, 2) select whether to allow consumer to “make an offer”, and 3) if “make an offer” is selected, a retailer can set minimum “make an offer” price or price range that retailer is willing to accept for the product. If the retailer allows “make an offer” for the product, the consumer can choose to “make an offer” by selecting a price they are willing to pay for the product and submitting it to the system for a response. Additionally, in some embodiments the system can still use an automated feature using an algorithm to sort offers to the retailers and make automated responses if the offer does not fall in the price range. Offers that do fall in the price range can be provided to the retailer for them to reply to manually. This can help screen extremely low offers so retailers are not receiving offers they would consider. The system will provide notification 323 to the retailer or its authorized users (i.e. email, retailer web/mobile portal, text) and the retailer may manually respond with output 311 either by accepting the consumer offer, rejecting the consumer offer, or responding with counter-offer (price) that consumer can choose to accept or reject. When the retailer and consumer accepts the offer proposal, the consumer can then choose to buy and initiate the standard online purchase process 317.

FIG. 4 illustrates a “Get Offers” method or process 400 for a consumer user to obtain products or services by soliciting offer requests or to “get offers” from a retailer user of a desired good or service. The consumer can post a request on the system for a general product or service, or a specific product or service they are interested in purchasing and desires to receive offers or bids from retailers having the same or similar desired product or service.

Consumers can initiate 401 a product offer requests for very specific, as well as general (i.e. 50″ television) products through the system in multiple ways, such as 1) selecting to “get offers” while viewing a specific product page, 2) when searching for products, 3) accessing the “get offers” page from their account lounge, and 4) from the consumer's “favorites” page. When on the “get offers” page, a consumer is guided via a conversational graphical user interface (GUI) to select from configurable fields in screen (e.g. product place, category, type, brand, color, material, finish, size, gender, delivery preferences, purchase timeframe, price range) and add any custom notes or requirements (or even images) for their product or order.

In one embodiment, the consumer may post a desired product or service request within a category that is defined, (e.g. electronics, spa services, fitness equipment). In another embodiment, the consumer is able to navigate a hierarchy of categories toward an increasing level of detail, until they reach the level of detail for which they are interested in receiving an offer from a retailer. For example, the hierarchy for the first data 403 to be included for a television may include, 1) Electronics 2) Television 3) Flat screen television 4) Size of television 5) Display type 6) Specific brand 7) Specific model). The data entered by the consumer can be considered a first data 403 set. The consumer can submit a request 405 using the first data set or edit 404 the data set before submitting the request. The requested data set can then be compared against which a matching algorithm 407 is used to compare and establish an analytic scorecard against retailer data sets, which can be a second data set.

In other embodiments, the consumer may directly post the product or service they desire directly, without having to navigate a product hierarchy. Similarly, a consumer can use terms in a search field into the system with the system providing product options based on the search criteria provided.

A retailer can generate a data set of its products or services, and either during the account setup process 409 or later in the account section of their web portal/app, can select the product places, product categories, product types, brands, and other key information about consumer offer requests that they would like to receive. Additionally, either during the account setup process or later in the products section of their web portal/app, a retailer can upload or enter the specific products they wish to sell thru the system, such as the product information 200 shown in FIG. 2.

A first data set can be entered into the system by a consumer and can require information, such as a consumer user ID, consumer name, gender, consumer score, address, and product information (place, category, type, price range, delivery method, timeframe, and attribute ratings). The first data set can include option information including product sub-type, brand, finish, material, size, color, condition, etc. A second data set can be entered into the system by a retail user that can include a retail user ID, retailer name, logo or image, delivery range, location, etc. The second data set can include similar product information as the first data set, including a product ID number, product place, product category, type, sub-type, code, name, description, quantity available, price, minimum offer price (if applicable), shipping and delivery information,

Once a consumer has submitted their offer request, the system can implement a matching algorithm configured to parse the consumer request and identify the appropriate retailers to send a “get offer” request to. This matching algorithm 407 can assign an analytic scorecard to data sets in order to identify similar products and services as those requested by the consumer. Additionally, a coefficient factor can be applied to generate the analytic scorecard of a data set. Each retailer generated by the matching algorithm 407 will receive notification 413 of the new request (email, web portal/app alert, etc.). A retailer may then elect to create/submit an offer, or ignore the consumer's request through the system. In one optional aspect, once a consumer initiates a request, retailers will have only a pre-determined amount of time to respond the consumer request.

The matching algorithm 407 continues to iterate and generate matching data between a first data set and plurality of second data sets until the pre-determined time expires or a consumer has selected and purchased a product and closed offers or closed the offer period for the product for which they have requested offers.

Retailers can create and deliver their offer for the consumer through the system's guided GUI 423, either by selecting and customizing a product they've already uploaded to the platform, or by entering a new product 411. Once submitted, these offers can be edited by the retailer until the consumer's request has ended.

An analytic scorecard can be used in tandem with an offer algorithm 419 to optimize the product offers generated by the matching algorithm. Email, text, and app notifications can also be provided. If no offers are received after a pre-determined amount of time, the system will automatically close the request and notify the initiating consumer. The system may also notify the consumer that the bidding process has ended after the expiration of a pre-determined amount of time, or that their bids will expire in a set amount of time duration.

As offers are received from retailers, the consumer can view the offers and either close the offer request (if no satisfactory offers received), or select an offer and initiate the transaction process. This transaction can be carried out through a standard online transaction with any suitable means, including e-wallet, credit or debit card, a direct checking account, or PayPal®. Additionally, the consumer can designate a local transaction to occur, where the consumer will pay upon receiving goods or services from the retailer in person.

In another optional aspect, the consumer is able to choose a date by which they want to stop receiving offers from retailers. The consumer can also provide special requests or instructions for a retailer to consider in making their offer, for example a consumer may need a loaner car when requesting a car repair service. The consumer can optionally attach pictures, web links, files (e.g., a Word or Excel document), and other attachments that may be beneficial to the retailer in making an offer. The consumer is able to post requests through a Web interface, a mobile app, or through other posting methods.

Similarly, as shown in FIG. 4, retailers can determine either during the account setup process or later in the account section of their web portal/app whether to automate 415 consumer offer requests with a response or to manually 417 respond to consumer requests for offers. When a retailer has designated to use the automated 415 response feature, the system's offer algorithm 419 can parse the consumer's product request information, and select, based on all information available in the retailer's uploaded product catalog, the best product and price to respond with an offer to the consumer 423. As noted above, the offer algorithm 419 or another algorithm can be used to preferentially order the list generated to include better matches based on the analytic scorecard at the beginning of the list. If no close matches are found for a given retailer, the system can choose to ignore 425 the request on that retailer's behalf. Similarly, in the manual 417 process, a retailer can select to ignore a user request. This automated offer response can contain the retailer's information, a product place, category, type, price, delivery details, images, special features, and other dynamic product level information. Each retailer employing the automated response method will receive notification 427 of the request and offer details (i.e. email, web portal/app alert, SMS), and will have the ability thru the system to edit any of the offer details until the consumer's request has ended after a pre-determined amount of time or by selection and purchase of an offer by the consumer.

Once a consumer posts the product(s) and service(s) they are seeking to purchase, in one embodiment, the system forwards the request to the list of retailers registered to respond to that request through the system, e-mail, or other method. In yet another embodiment, the retailer has the ability to search for or access requests through a user interface to the system.

A retailer wishing to respond to an offer may post their offers on the system. The retailer may attach pictures, web links, or other attachments that provides information that may be useful to the consumer in considering the offer. The retailer, or in another embodiment, the system itself, may also post an expiration date for the offer, or a date range during which the offer is valid. In one embodiment, when the expiration date is reached and the offer is not accepted by a consumer, the offer is removed by the system. A consumer and retailer are also able to post a question and answer to clarify the offer and any related request. All offers and questions are posted on the system and are immediately able to be viewed by a consumer. In one embodiment, the consumer may elect to be notified via e-mail, SMS text, through the system interface, through a mobile app, or other method when a request or question is posted for their request 429. A retailer is able to post additional comments for the consumer making the request to consider as part of the offer. In one embodiment, the retailer is able to modify or withdraw an offer after it has been posted.

When a consumer receives one or more offers, the consumer may choose to accept an offer, respond with a question, decline an offer, or let offers accumulate. A consumer may access these options through a user interface on the web, through a mobile app, or through other means. The response is recorded in the system and notification is provided to the retailer making the offer through the same means detailed elsewhere in this document.

Each offer 429 provided to the consumer identifies the retailer's current price. As the matching algorithm 407 continues to iterate, a new set of active bid values typically are generated, and a new offer can be provided through the offer algorithm. This process can continue until the user's “get offers” request expires. The user may accept the offer before time runs out, or the offer may be eliminated or sold-out. Additionally, retailers may be notified that their offer was not accepted because the consumer cancels the solicitation request or purchases from another retailer without keeping offer open.

A consumer can accept 431 one or more offers for purchase if so desired. The consumer can close the “get offers” request at any time including when selecting an item to purchase. However, the consumer may also leave the “get offers” request open even after purchasing an item. The system can allow a consumer to respond to any particular offer with questions or other requests, without having to make the purchase at that time. In some embodiments, the original offer will remain available until either the date of the offer made by the retailer expires, or the retailer withdraws the offer.

When an offer is accepted, the consumer can close the transaction by checking out 433 through one of several options, including, but not limited to: A) Making payment through the system via a credit or debit card, payment service, or other transfer of funds; and indicating their choice of options provided (if there are multiple options) for pick-up or delivery, or B) indicating that the consumer will pay for the transaction in-person at a particular location, such as a store. If (A) the payment is made through the system, the payment is processed through an appropriate payment processing system.

A consumer may also decline offers 435 as they are received, at which point a retailer may receive a notification of the declined offer. The retailer could then reply back with a new offer as long as the consumer offer request was still open. Once the period to receive offers has expired, the consumer can decline all the offers, thereby ending 437 the “get offers” request. Similarly, at any point, a consumer can determine to stop receiving offers to end the “get offers” request period. Optionally, offers can also be declined or lapse by retailers if a consumer does not accept the offer before the pre-determined amount of time.

Once the payment is processed, the order is delivered through the system or other means, such as a batch feed or other electronic method of data transfer, to the retailer. The transfer of funds is made through the method pre-selected by the retailer. In one embodiment, marketplace fees associated with the transaction are withheld from the payment to the retailer. Payment by a consumer user to a retail user can be collected through the system. A fee can applied and deducted by the system to the transaction, and the remainder of the funds from the transaction can be delivered directly to a Retailer (e.g. a bank account or some other escrow account owned by the retailer). The system can provide information regarding the shipping of the goods by the retailer and additionally any tracking information linked to the shipment of goods.

Access to the data regarding delivered orders may occur through a batch background process, or in a real-time background process to support the ability to post a request while shopping (online or in person) and enable businesses to respond immediately based on the business's desire to fulfill a consumers “get offers” request. The data can be used to create a consumer loyalty scorecard, which retailers can use to aid in determining offers made to particular consumers.

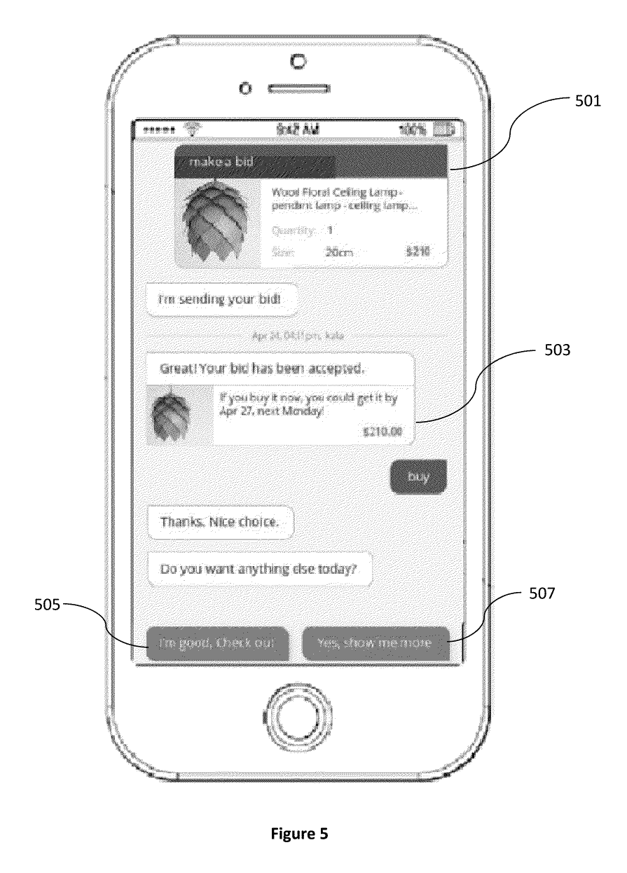

One exemplary embodiment of the system for the “make offer” approach allows a consumer user to make offers through a mobile device. FIG. 5 illustrates a user interface on a mobile device a consumer can use to make an offer or bid 501 on a product and the conversational and interactive GUI of the system when making a transaction using the “make offer” procedure. Using an algorithm the system can generate an automated response 503 back to the consumer notifying them if their offer was accepted. In other embodiments the system can allow a retailer to provide a manual response. The consumer can then go on to purchase and checkout 505 the item through the system or continue searching 507 for other items.

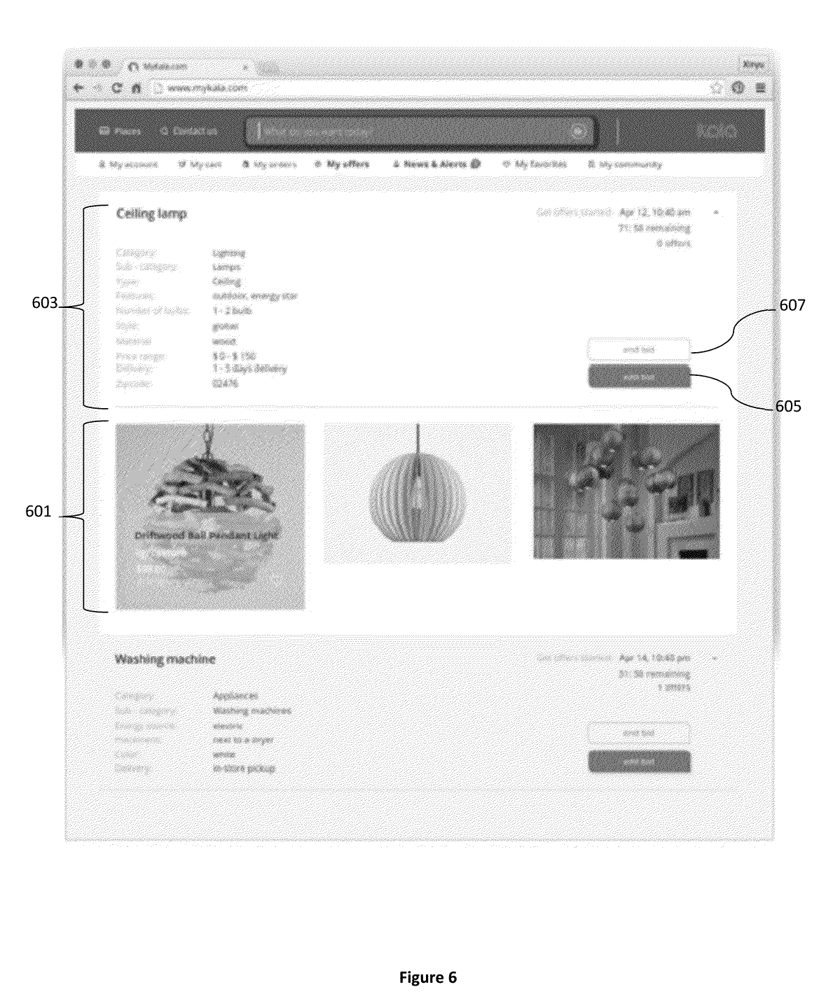

After submitting a product or service request for which the consumer would like to receive offers, consumers can check status of incoming offers at any time by logging into their system accounts. FIG. 6 illustrated a GUI of an exemplary embodiment of the present invention, where a consumer can logon to his or her account to view their current offers 601 from retailers, as well as the details 603 of the “get offer” bid they submitted. A consumer is able to edit 605 or end 607 their bid at any time during the “get offer” process.

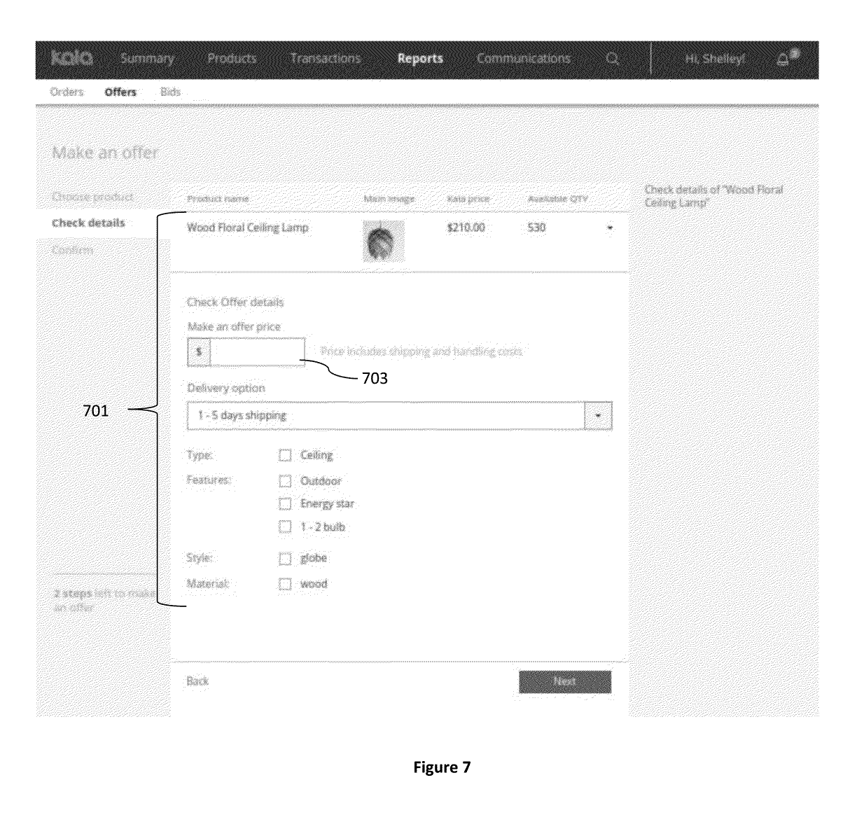

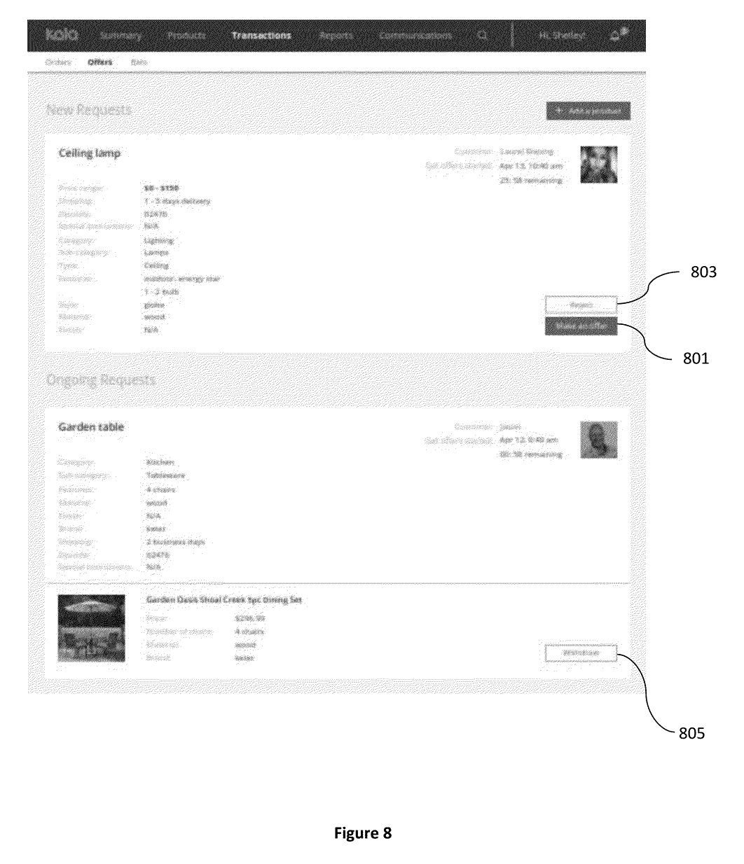

In another embodiment of the system, retailers may post product or service offerings on the system, either within categories or at another level. A consumer may optionally elect to make a purchase directly through a posted offering using a “buy it now” feature. FIG. 7 illustrates a web-based GUI for retailers to list items on the system that allow a consumer user to make an offer on a product or service. The retailer can provide the necessary product details 701, including the “make an offer price” 703 the retailer is willing to accept when offered by a consumer on the item. Once the retailer has filled in the necessary details the system can trigger an automated response to a consumer user notifying them whether their offer was accepted or rejected. FIG. 8 illustrates a web-based GUI for retailers, which have elected to be notified of potential “get offer” bids submitted by a consumer. The GUI can show new requests submitted by consumers as well as ongoing requests on which the retailer has previously made offers. The retailer is able to make an offer 801, reject the request 803, or ignore the bid. These responses can be setup by the retailer to give automated offers. Similarly, after making an offer, the retailer can withdraw 805 his offer manually or setting up an expiration date upon which the offer will expire. The GUI can also show the data from the second data set entered into the system by the consumer that reflects the details of a product for which the consumer wishes to receive offers.

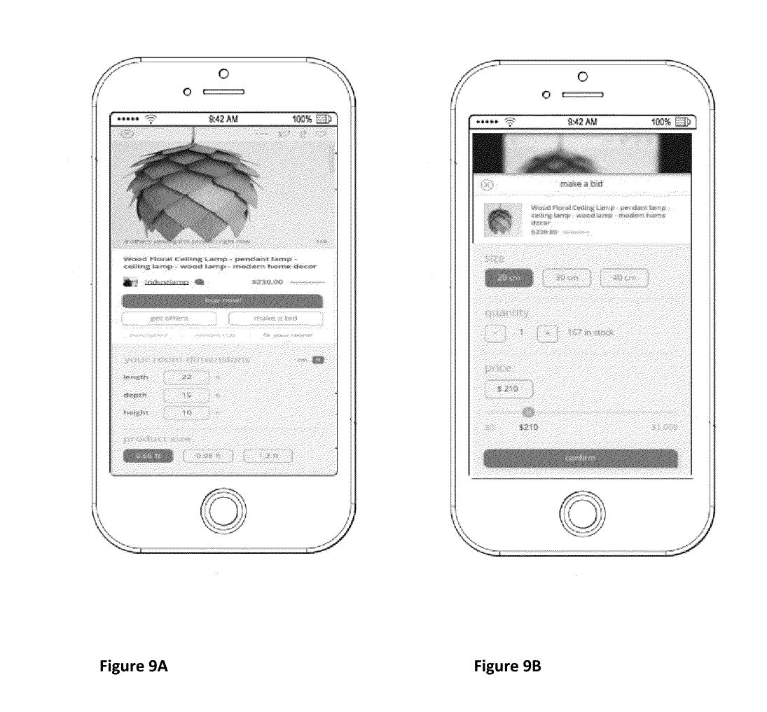

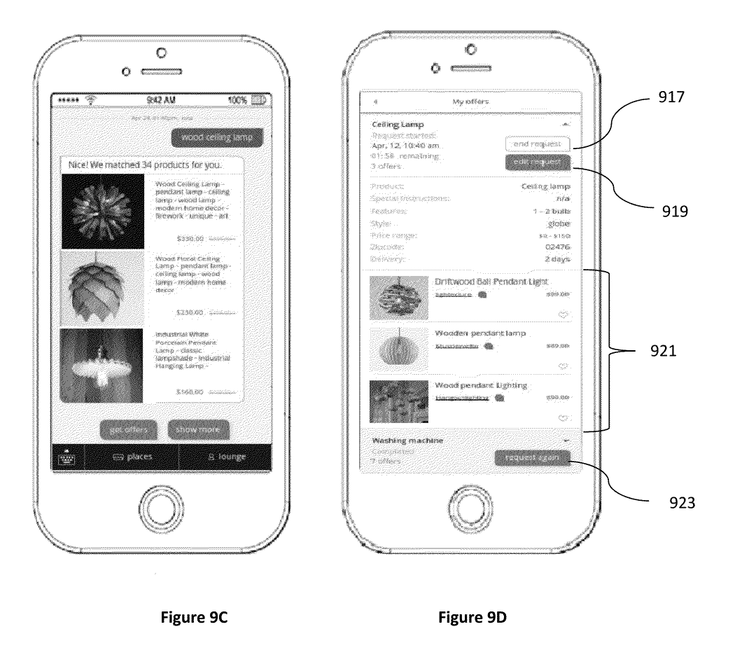

A user can easily navigate the system platform through multiple wireless devices. FIGS. 9A-D illustrate an exemplary embodiment of a GUI for navigating the system. FIG. 9A illustrates a product that has been posted by a retailer with aforementioned pathways for purchasing the product (“get offers”, “make an offer”, “buy it now”). It also illustrates an option for a consumer to specify different required features of the goods or services. FIG. 9B illustrates the “make an offer” interface that provides the consumer various options regarding the product and the price they wish to bid for the product or service before the offer is sent to the retailer or responded to by the system. Similarly, FIG. 9C is an illustration of a GUI that has populated results for a consumer after requesting to “get offers” from retailers on a similar product that was shown in FIG. 9A. FIG. 9D illustrated a GUI of a consumer who has sent out a “get offer” request that has received offers 921 from retailers. The options to end request 917 if a consumer decides he no longer wishes to receive offers or edit request 919 if the offers being received are not exactly what the consumer wants to purchase. In an exemplary embodiment, at the expiration of the get offers period a consumer can also request again 923 to get offers using the same data set as before. The interface can also display the timer remaining on the request for offers. Additionally, the system can allow a consumer to organize and view all of their requests, as well as the details of each request, the responses to their requests, and all open, pending, and closed or fulfilled requests. The system can also allow a consumer to observe and be notified of new offers, expiring offers, withdrawn offers, and other such attributes.

Although the current embodiments are described with respect to retail services, it should be noted that the system may also be adapted for additional industries, such as healthcare, travel, education, or others. Additionally, the businesses may utilize the system to determine other product or service offerings or discounts to provide to a customer at the time the customer is seeking an offer.

While the embodiments have been illustrated and described in detail in the drawings and foregoing description, the same is to be considered as illustrative and not restrictive in character, it being understood that only certain embodiments have been shown and described and that all changes and modifications that come within the spirit of the embodiments are desired to be protected.

What is claimed is:

1. An apparatus for managing and making transactions in an interactive social e-commerce environment, comprising:
at least one hardware processor,
a server, the server configured to receive a plurality of data sets;
a computer memory storing a database configured to store a plurality of algorithms and the plurality of data sets, wherein each algorithm assigns an analytic scorecard for each data set, the analytic scorecard determined by a comparison of said first data set to any one second data set;
wherein said computer memory further stores computer program code executed in the hardware processors to:
establish and maintain said plurality of data set and plurality of algorithms;
receive a first data set from a user defining a product or service said user desires to obtain and a first pre-determined time period in which the user desires to obtain offers for said product or service;
execute iteratively an algorithm to automatically retrieve from said memory a plurality of second data sets based on an analytic scorecard comparison between said first data set and second data sets;
populate a set of offers related to each the second data sets based on said analytic scorecard, wherein said offer are correlated to a given one of retailers;
provide outputs to a user, together with any update to an output that results from an iteration of said algorithm, wherein each offer has a given pre-determined duration before said offer is removed;
take an action based upon receipt of said offer by said user, wherein the action facilitates an online transaction between the user and a given one of retailers associated with an offer.

2. The apparatus of claim 1, wherein said action between said user and retailer associated with an offer is executed by the apparatus.

3. The apparatus of claim 1, wherein said action between said user and retailer associated with an offer is executed by a third party.

4. The apparatus of claim 1, wherein said second data set comprises product type, product location, product brand, and product price.

5. The apparatus of claim 1, wherein said first data set includes a value range user is willing to pay for said product or service.

6. The apparatus of claim 1, further comprising a graphical user interface.

7. The apparatus of claim 1, wherein said offer populated by said apparatus are automatically populated.

8. The apparatus of claim 1, wherein said offer are populated manually by said retailer.

9. The apparatus of claim 1, wherein said action based upon receipt of said offer by said user further comprises the offers being generated in a list and in a manner to avoid undesired data, wherein the offers are preferentially ordered in the list based upon iterative execution of said algorithm.

10. The apparatus of claim 9, further comprising a middleware box configured to provide application program interfaces for said users.

11. The apparatus of claim 10, wherein the executed iteratively algorithm uses a coefficient factor score to generate said analytic scorecard.

12. The apparatus of claim 1, wherein hardware processor alternatively executes program code allowing said user to make an offer related to the second data set based on the analytic scorecard and said computing entity generates an automated offer response by executing a second algorithm against said second data set, wherein said offer response can accept or reject said offer.

13. A method for managing and making transactions in an interactive social ecommerce environment, comprising:
establishing and maintaining, within a computing entity, a plurality of data sets and plurality of algorithms;
receiving a first data set from a user defining a product or service said user desires to obtain and a first pre-determined time period in which the user desires to obtain offers for said product or service;
executing iteratively an algorithm to automatically retrieve from said memory a plurality of second data sets based on an analytic scorecard comparison between said first data set and second data sets;
populating at least one offer related to each the second data sets based on said analytic scorecard, wherein said offers are correlated to a given one of retailers;
providing generated offers to a user, together with any update to an offer that results from an iteration of said algorithm, wherein each offer has a given pre-determined duration before said offer is removed;
taking an action upon receipt of said offer by said user; wherein said offers are generated in a list and in a manner that avoid undesired data, said offers are preferentially ordered in said list based upon iterative execution of said algorithm, and the action facilitates an online transaction between the user and a given one of retailers associated with an offer.

14. The method of claim 13, wherein the transaction between said user and retailer occurs online.

15. The method of claim 14, wherein the transaction between said user and retailer occurs in person.

16. The method of claim 13, wherein said second data sets are provided by a retailer.

17. The method of claim 13, wherein said computing entity alternatively allows a user to make an offer related to a second data set based on the analytic scorecard and said computing entity generates an automated offer response by executing a second algorithm against said second data set, wherein said offer response can accept or reject said offer.

18. The method of claim 13, wherein said second data set includes a make offer price data point.

19. The method of claim 13, wherein the executed iteratively algorithm uses a coefficient factor score to generate said analytic scorecard.

20. A system for a consumer driven offer program that allows a consumer to post requests for product and service offers, comprising:
a software adapter executed by a data processor to retrieve consumer data over a wide or local area network;
a consumer database server comprising operational software and a plurality of consumer accounts, the database server configured to store the consumer data, store records relating to product and service requests, the consumer requests stored in a consumer account, wherein the database server is operable to transmit the consumer requests to retailer accounts; and
a retailer database server comprising operational software and a plurality of retailer accounts, the database server configured to store the retailer data, records containing product and service data and descriptions, and other data in a form accessible to registered retailers;
wherein said data processor executes iteratively at least one algorithm comparing said consumer requests to said product data;
at least one offer related to the consumer request is populated, wherein said offer is correlated to a given one of retailers;
providing generated offers to a user, together with any update to an offer that results from an iteration of said algorithm, wherein each offer has a given pre-determined duration before said offer is removed; and
taking an action upon receipt of said offer by said user;
wherein said offers are generated in a list and in a manner that avoid undesired data, wherein said offers are preferentially ordered in said list based upon iterative execution of said algorithm; and the action facilitates an online transaction between the user and a given one of retailers associated with an offer.
